(19) United States
(12) Patent Application Publication
(10) Pub. No.: US 2026/0111675 A1
(43) Pub. Date: Apr. 23, 2026

(54) INTENT DETECTION FOR LARGE LANGUAGE MODEL POWERED CHATBOTS

(71) Applicant: Salesforce, Inc., San Francisco, CA (US)

(72) Inventors: Ben Maddox, Redwood City, CA (US); Sandeep Poman, Pune (IN)

(73) Assignee: Salesforce, Inc., San Francisco, CA (US)

(21) Appl. No.: 18/923,534

(22) Filed: Oct. 22, 2024

(51) Int. Cl. G06F 40/30

(52) U.S. Cl. CPC G06F 40/30

(57) ABSTRACT

A method for performing a dialog session including receiving a user input from a chatbot application wherein the user input is indicative of a user intent associated with one of a plurality of skills, generating an input vector in response to the user input, generating a list of skills in response to a semantic search comparing the input vector to a plurality of skills vectors where each of the plurality of skills vectors is associated with one of the plurality of skills with the vector to determine a list of skills matching the vector, identifying an intended skill from the list of skills in response to the list of skills and the input vector using a large language model, and performing the intended skill in response to the identification of the intended skill.

### TECHNICAL FIELD

Embodiments of the subject matter described herein relate generally to chatbot dialog system and algorithms. More particularly, embodiments of the subject matter relate to a method and apparatus for implementing a chatbot system to enable a semantic search on a user input to generate a short list of skills for use as an input by a large language model.

### BACKGROUND

People are turning more and more to the internet to get information related to a company's products and services. In turn, companies are providing more and more information online regarding their products and services, often foregoing printed information altogether. This may make finding information regarding a particular aspect of a product or service difficult for a user to locate online. To address this problem, Chatbots are being employed to quickly answer user questions and to quickly direct a user to their desired information. A Chatbot is a program which can simulate a human conversation by receiving natural language input and provide responses in a natural language format. Chatbots pose questions to a user and receive user input in a conversational, natural language format. The Chatbot program then converts the natural language input received from the user to a set of key words used to determine an input intent and to formulate a response. The programs behind the Chatbot can analyze a user input to provide the requested information, direct a user to an appropriate web location, or to initiate a more focused Chatbot session related to the user requirements.

Chatbot sessions are often provided as website popups or entry fields on a webpage and may be implemented using a combination of one or more of rules, keywords analysis, and artificial intelligence. Chatbot sessions are typically designed to address a particular user requirement with new Chatbot sessions initiated in a continuous fashion in response to a user input. For example, an initial Chatbot session may ask a user “How may we help you? ” In response, the user may enter “open new account” and the Chatbot may complete the initial Chatbot session and open a new chatbot session related to opening new accounts. This change in session may not be obvious to the user. Single Chatbot sessions with overly complex use cases may be unreliable and may be frustrating to a user.

Chatbot administrators can configure natural language processing elements associated with logical elements such as dialogs and rules to pose user questions and provide appropriate answers to Chatbot session users. Large language models (LLMs) are sometimes used for chatbot sessions due to their ability to process and generate human-like text. The vast training datasets of LLMs enable them to understand and respond to a wide range of queries and prompts. LLMs can often provide informative and engaging conversations, offering a personalized experience for users and their adaptability allows them to learn from interactions and improve their responses over time, making them ideal for dynamic and evolving chatbot applications. However, while LLMs offer impressive capabilities, their limitations can hinder their suitability for certain chatbot applications. Primarily, the cost of invoking an LLM for intent detection can be substantial, and this expense increases as more skills are integrated. Additionally, the accuracy of intent detection tends to deteriorate as the number of skills grows, with real-world applications often observing a significant drop in accuracy beyond around 20 skills. Finally, there is a trade-off between intent detection accuracy and LLM response time, where higher accuracy often comes at the cost of increased latency. These limitations can hinder the efficiency and effectiveness of LLM-powered chatbots in certain scenarios. Accordingly, it is desirable to develop a Chatbot session system using taking advantage of the many benefits of LLM while minimizing the potential limitations. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows an exemplary system for intent detection for LLM powered chatbots according to an exemplary embodiment of the present disclosure.

FIG. 2 is a flowchart of a method for intent detection for LLM powered chatbots according to an exemplary embodiment of the present disclosure.

FIG. 3 is a block diagram of an exemplary system for intent detection for LLM powered chatbots according to an exemplary embodiment of the present disclosure.

FIG. 4 is a flowchart of a method for intent detection for LLM powered chatbots according to an exemplary embodiment of the present disclosure.

The exempliﬁcations set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

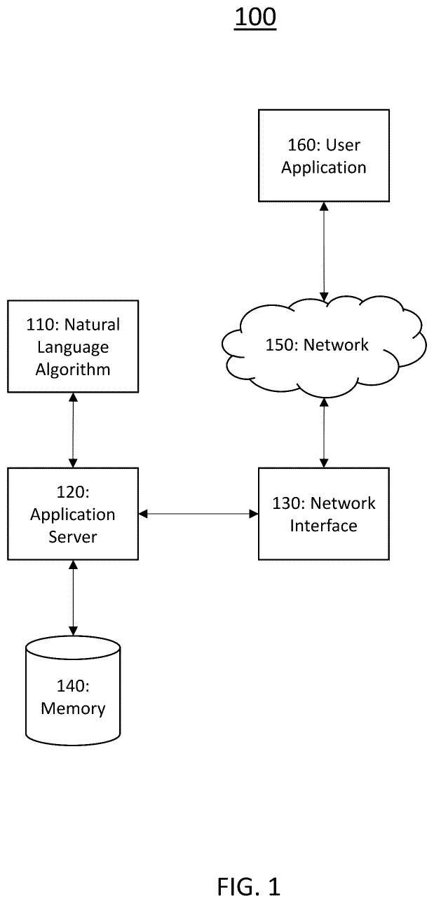

Turning now to FIG. 1, an exemplary system 100 for intent detection for LLM powered chatbots according to an exemplary embodiment of the present disclosure is shown. The exemplary system 100 shows a complex system for performing a chatbot session including a natural language algorithm 110, an application server 120, a network interface 130 and a memory 140. The network interface 130 can be communicatively coupled to a communications network 150, such as a local area network, wireless local area network, or the internet. In some exemplary embodiments, the scale of the system 100 may vary and may include fewer or additional components than those described here. In some exemplary embodiments, the system 100 may occur remotely where components are distributed across one or more devices of a distributed network.

A chatbot is an artificial intelligence program designed to simulate human conversation. A chatbot is capable of interpreting and responding to natural language inputs and can be used for a variety of human machine interface applications. Chatbots can be used to provide customer support, answer frequently asked questions, and assist with complex tasks. Their ability to process information and respond in a timely manner makes them an increasingly important component of modern business operations.

Chatbots leverage a plurality of resources, including internal and external natural language processors, machine learning, analytics services, and third party services to generate a response to user communications and take actions on behalf of the user. The use of the natural language processing and other additional information allows the application server 120 to generate an appropriate response to user natural language queries received at the user application 160.

LLMs are one example of advanced deep learning architectures designed to process human language to interpret the natural language user inputs received by the Chatbot application. LLMs are trained on very large datasets to leverage transformer architectures to understand the semantic relationships within text sequences. Unlike earlier sequential models, transformers process entire sequences in parallel, enabling more efficient training and scaling. LLMs are capable of unsupervised learning, mastering grammatical structures, languages, and knowledge through self-training. Their applications span diverse domains, including text generation, translation, summarization, and question answering. While LLMs offer significant advantages for chatbots, they can be computationally expensive to train and run, making them challenging to deploy in real-world applications with limited resources. Additionally, LLMs may not scale well and can have undesirable response latency. In order to address these challenges using the LLM, the natural language algorithm can use a semantic search on the natural language user input to refine the input to better predict a user intent to be provided as an input to the LLM.

An exemplary user application 160 may be performed on a user device, such as a computer with web browser, mobile device or the like. The user may initiate a Chatbot session in response to a user input transmitted from the user application 160 to the network interface 130 via the network 150. The application server 120 may perform the Chatbot session in response to the initiation from the user application 160. For example, the user may request a webpage. A timer can then be initiated after transmission of the webpage. If no further user action is received, the Chatbot session may be initiated by the application server 120. The Chatbot session may first include transmitting an initial question for presentation to the user within a Chatbot window.

Alternatively, the user may click on a Chatbot session initiation button within the user application 160. Metadata associated with a current state of the user application 160, user information and/or user application history may be transmitted with the Chatbot session initiation request in order to further refine the Chatbot session to the user requirements.

In some exemplary embodiments, the application server 120 running the Chatbot session may receive a natural language text input from the user via the user application 160. The application server 120 next interprets the natural language text input to generate data that can be used by the Chatbot program to generate accurate Chatbot responses. The application server 120 can first preprocess the natural language text to remove common words, segment or tokenize the received text, and tag the parts of speech in the natural language text, such as nouns, verbs and adjectives. The application server can next perform a semantic search on the preprocessed text in order to better understand the meaning of words and phrases in a query to provide more relevant search results. Semantic search converts natural language information into numerical representations that can be compared and ranked based on semantic similarity. A semantic search can convert the query into numerical representations called vectors. For example, each word or token can then be assigned a numerical vector representation. This representation captures the semantic meaning of the word, considering its context and relationships with other words. Techniques for generating word embeddings can include Word2Vec, GloVe, and FastText.

The determined vector can next be compared to stored vectors to predict a user intent. For example, the application server 120 can use the determined vector to perform a semantic search on a database of utterances wherein the utterances are also represented by vectors. The application server 120 can then generate a shortlist of utterances that most closely match the determined vector. If the semantic search returns a result with a high degree of match, the skill associated with that result can be returned to the Chatbot session. If the results have a lower degree of match, a prompt for use by the neural network can be generated using the results. In some exemplary embodiments, a cosine similarity between the query vector and the utternace vectors can then be calculated to measures how similar the vectors are in terms of direction, indicating semantic similarity. The utterances can be ranked based on their cosine similarity scores with the query. The utterances with the highest scores can then be considered the most relevant.

In some exemplary embodiments wherein the Chatbot session is configured to initiate a skill in response to a natural language user input, a semantic search is first performed on the natural language text received from the user input. A vector is generated from the natural language text and this vector can be compared against a database of skills associated with a vectors generated from sample utterances. If there is a close match, the skill is enabled. If there is not a close match or an overlap of skills, a shortlist of skills is generated and sent to the LLM with the user input. The LLM returns the most likely skill from the shortlist associated with the user input. In addition, the skill received from the LLM results can then be used to train the semantic search. Also, if the input from the user is particularly long, it can immediately be send it to the LLM with the prompt to ‘determine user intent’ and then use that to generate a vector to use in our semantic search. Once the intent is matched, the chatbot activates the corresponding skill. This might involve calling a pre-defined function, triggering a script, or invoking a specific API. In some exemplary embodiments, the activated skill can then processes the user's query further, potentially gathering additional information or performing actions as needed. The skill can generate a suitable response based on the processed input and its own logic. This response is then sent back to the user.

After preprocessing, the application server 120 can next use a natural language processing algorithm to process the natural language text input. LLMs are artificial intelligence (AI) models trained on very large amounts of text data, enabling them to learn complex patterns and relationships within a human language thereby allowing them to better decode the intricacies and variations within the human language. The LLM training process is typically unsupervised, where the model learns from the data without explicit labels or guidance. For particular natural language processing tasks, a pre-trained LLM is fine-tuned on smaller, more specialized datasets in order to adapt its knowledge to specific requirements. The fine-tuning process guides the LLM to perform tasks like machine translation, sentiment analysis, or text generation more effectively. LLMs can translate text from one language to another, understanding the nuances and context of the original language and can condense long texts into shorter summaries while preserving key information. LLMs can provide informative answers to a wide range of questions based on their understanding of the text and can generate creative text, such as poems, stories, or code snippets. LLMs can determine the sentiment expressed in text, identifying whether it's positive, negative, or neutral. Finally, the natural language processing algorithm returns inquiry data to the application server 120 useful for searching a response database and generating an appropriate user response in the Chatbot session.

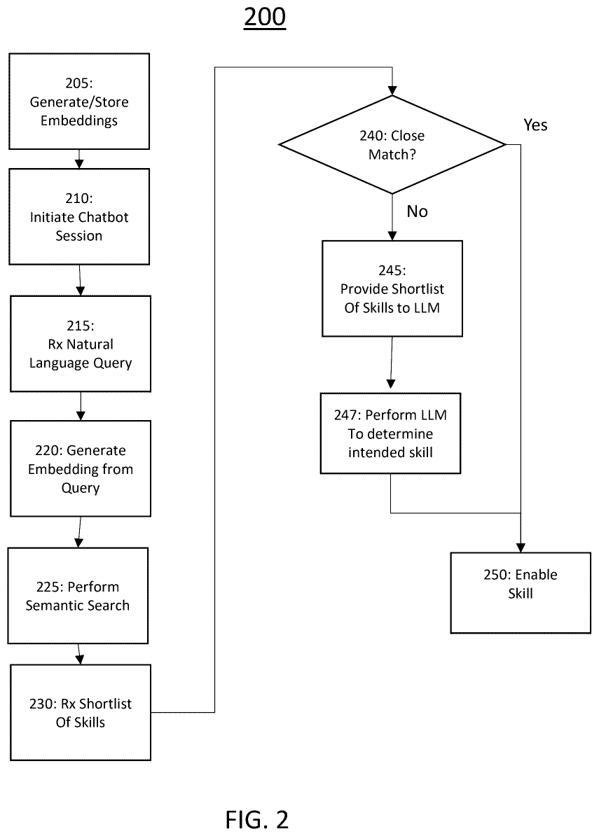

Turning now to FIG. 2, a flowchart 200 of a method for intent detection for LLM powered chatbots according to an exemplary embodiment of the present disclosure is shown. The exemplary method 200 may be performed by a processor or the like coupled to a non-transitory computer readable medium having computer instructions stored therein that when executed by a computer system cause the computer system to perform operations. The processor may be coupled to a network interface and a memory wherein the memory is employed to store a ruleset data and the generated metadata, such as outcome data or outcome logs. The memory may be one or more memory devices such that the ruleset data, natural language conversion data and algorithms and the generated metadata are stored on separate memory devices.

The method is first configured for generating 205 and storing a plurality of embeddings for each of a plurality of skills that may be performed in response to the chatbot application. Embeddings, or vectors, in a chatbot application are numerical representations of words, phrases, or even entire sentences. These representations capture the semantic meaning of the text, allowing the chatbot to understand and process language in a way that is more meaningful than simply treating words as individual tokens. The embeddings can be stored in a memory communicatively coupled to a natural language processor or a processor configured to perform a natural language processing algorithm.

The method is next configured to initiate 210 a chatbot session. The chatbot session may be performed by an application server communicatively coupled to a communications network, such as a local area network and/or the internet. The chatbot session may be initiated in response to a user request, to an algorithm or timer performed in combination with a user application, or in response to a request by another algorithm or chatbot session.

During the chatbot session, the application server can receive 215 a natural language query from a user. The natural language query may be generated by a user at a user interface and received at a network interface via a communications network, such as a local area network and/or the internet. In some exemplary embodiments, the natural language query may be in the form of a sentence or an unstructured combination of words.

The method next generates 220 an embedding in response to the natural language query. The embedding can be generated from the input text through a multi-step process. Firstly, the input can be tokenized into individual words or sub words. Subsequently, each token is assigned a numerical vector representation using pre-trained or custom embedding models. Finally, these word embeddings can be combined to create a sentence embedding, representing the overall semantic meaning of the input.

The method next performs 225 a semantic search to compare the plurality of embeddings stored in the memory with the embedding generated in response to the user inquiry. In some exemplary embodiments, the method can determine the cosine similarity or Euclidean distance between the query embedding and the skills related embeddings stored on the memory. The skills embeddings are then ranked on their similarity to the query embedding. The top-ranked skills are returned as the semantic search results

The Chatbot application server next generates 230 results in response to a response data received in response to the structured database query. The results can include a list of top ranked skills and an indication of how close each embedding matched the embedding generated in response to the user inquiry. The method may next determine 240 if the embedding representing the top ranked skill was a close match to the embedding generated in response to the user inquiry. If there is a close match, the method then enables 250 the top ranked skill. If there is not a close match, the method can provide 245 a shortlist of top ranked skills and an input to an LLM. The method then performs the LLM 247 on the embedding generated in response to the user inquiry using the on the shortlist of top ranked skills to identify the most likely skill from the shortlist associated with the user input. In response to the received most likely skill, the method is then operative to enable 250 the most likely skill.

In some exemplary embodiments, the skill received from the LLM results can then be used to train the semantic search. Also, if the input from the user is particularly long, it can be immediately send it to the LLM with the prompt to ‘determine user intent’ and then the returned determined user intent is used to generate an embedding to use in the semantic search.

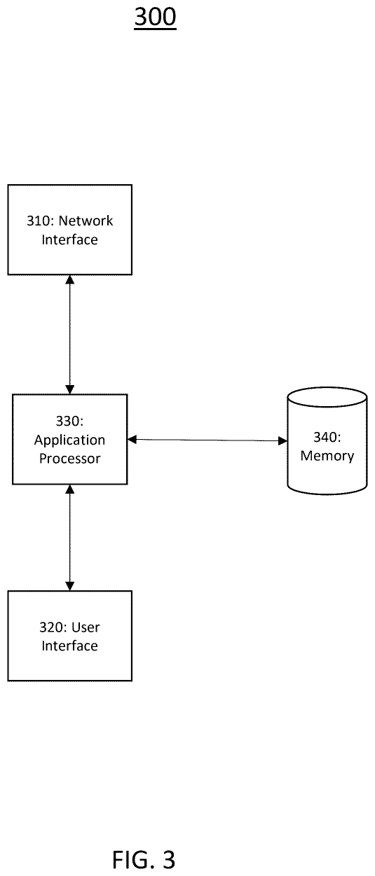

Turning now to FIG. 3, a system 300 for performing a dialog session algorithm and for generating an outcome log in response to a dialog session outcome according to an exemplary embodiment of the present disclosure is shown. The exemplary system 300 can include a network interface 310, a user interface 320, an application processor 330 and a memory 340.

The user interface 320 can be configured to execute a user application to receive and provide information to a user. In some exemplary embodiments, the user application may be a chatbot or dialog session for performing a customer relationship management application. The user interface 320 may be a smartphone, a personal computer, or other user electronic device. In some exemplary embodiments, a display on the user interface can display a chatbot session window wherein the chatbot session window displays natural language queries and responses generated by the chatbot session algorithm performed on the application processor 330 and may receive user responses and queries in response to user inputs. The various queries and responses can be transmitted between the user interface 320 and a network interface 310 via a communications network, such as the internet. The network interface 310 is configured to transmit and receive data from a communications network, to transmit and receive data from system sources, such as an application processor 330 and to decode and encode the received data into an appropriate format for further processing.

The application processor 320 can be configured for performing the chatbot session algorithm in response to information provided by the chatbot administrator, or the like, data stored in the memory 340, and information received from the user via the user interface 320. In addition, the application processor 330 may perform a natural language to structured language conversion algorithm to enable natural language queries received via the user interface 320 to be used by the application processor 330 to search databases, retrieve desired information, and to generate natural language responses to provide to the user via the user interface 320.

The application processor 330 may form part of an application server and can be configured to perform the dialog session algorithm. This can include receiving a natural language query, wherein the natural language query is generated in response to a user input in a dialog session, generating a structured database query in response to the natural language query, and generating a results metadata in response to performing the structured database query. The application processor 330 may next generate a natural language response from the memory in response to the results metadata. Alternatively, the application processor 330 may select one of a plurality of stored natural language responses stored in the memory 340. The application processor 330 may next couple the natural language response to the network interface 310 for transmission to the user interface 320.

In some exemplary embodiments, the user interface 320 can be configured for receiving a natural language user input indicative of a user intent. The user interface 310 can be designed to provide an input field for receiving the natural language user input, such as a text window, for facilitating natural language interactions and accurately capturing user intent. This field should be visually prominent and easily accessible, encouraging user interaction. In addition, the user interface 320 can incorporate features such as auto-suggest or predictive text. These suggestions can be based on historical user data, common queries, or predefined keywords. By offering relevant options, the UI can guide users toward more precise and effective communication with the chatbot, ultimately improving the overall user experience.

The exemplary system 300 can further include the memory 340 configured for storing a plurality of skills vectors wherein each of the plurality of skills vectors is associated with a skill to be initiated by a chatbot application. This memory 340 can be resident on a user device or a network server. The data can be transferred between the network server and the user device over a communications via the network interface 310.

In some exemplary embodiments the applications processor 320 can be configured to generate an input vector in response to the user input received at the user interface 330. The application processor 320 can perform a semantic search for comparing the input vector to the plurality of skills vectors stored on the memory 340. In response to this comparison, the applications processor 320 can generate a list of skills having a close match to the input vector. The applications processor 320 can then be further configured for identifying an intended skill from the list of skills in response to the list of skills and the input vector using a large language model. For example, when the application processor 320 is comparing each of the plurality of skills vectors to the input vector, a closeness value can be determined for each of the plurality of skills associated with each of the plurality of skills vectors. This closeness value can then be used to determine a match to one of the plurality of skills when the closeness value is less than the threshold amount. Likewise, if one of one of the plurality of skills is determined in response to the input vector matching one of the plurality of skills vectors with the closeness value being less than a second threshold amount and wherein the threshold amount is greater than the second threshold amount, the application can designation the identified one of the plurality of skills as an intended skill. This intended skill can the initiated and/or executed by the application processor 320 or a separate skills processor or the like.

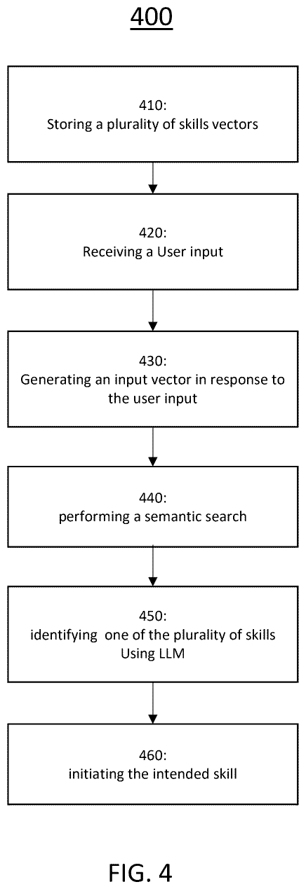

Turning now to FIG. 4, a flowchart of another method 400 for generation of signals and measurement of business goals in a chatbot platform according to an exemplary embodiment of the present disclosure is shown. The exemplary method may be performed by a processor coupled to a network for receiving data from a plurality of devices and may include devices of different types and categories. The processor can be configured to perform a dialog session algorithm associated with one or more business goals and wherein the one or more business goals are defined by a dialog session administrator and are associated with dialog session responses by the dialog session administrator.

The method 400 can first be operative for storing 410 a plurality of skills vectors in a memory wherein each of the plurality of skills vectors is associated with a skill to be initiated by a chatbot application. A skill vector is essentially a numerical representation of a specific skill or task that a chatbot can perform. This representation is typically created using techniques from natural language processing, such as word embeddings or document embeddings. For example, each skill can converted into a numerical vector by breaking down the skill description into individual words or tokens and then representing each word as a dense vector. These skill vectors are then stored in a suitable data structure, such as an array or a database having a data structure designed to efficiently store and retrieve these vectors based on their associated skills. To enable quick and efficient searching, the skill vectors can be indexed using techniques like inverted indexes or approximate nearest neighbor search to allow the chatbot application processor to quickly find the most relevant skill vector based on a user's query.

The method 400 can next be operative for receiving 420 a user input from the chatbot application. The user input can be a natural language query received from a microphone or a text window. The method 400 next generates 430 an input vector in response to the user input. The method 400 can generate the input vector from the natural language query through a process of text preprocessing and vectorization. Initially, the query can undergo text normalization, removing stop words and applying stemming or lemmatization to reduce the vocabulary. Subsequently, a word embedding model can be employed to convert the processed text into a numerical representation. These word embeddings capture the semantic meaning of words and phrases, enabling the method 400 to comprehend the context and intent of the query. By representing the query as a vector, the chatbot can effectively compare it to stored knowledge or skill vectors, facilitating the identification of the most relevant response.

The method 400 next performs 440 a semantic search with the input vector on the plurality of skills vectors to generate a list of skills matching, within a threshold amount, an intent of the user input. To execute a semantic search, the input vector is compared against a collection of stored skill vectors, each representing a distinct capability of the chatbot. By employing similarity metrics like cosine similarity or Euclidean distance to gauge the alignment between the input vector and each skill vector, the chatbot can identify skills that closely correspond to the user's intended purpose. A predetermined threshold value is frequently employed to filter out less relevant matches, ensuring that only skills exhibiting a high degree of similarity are included in the final list of potential candidates.

The method 400 is next operative for identifying 450 one of the plurality of skills in response to the list of skills and the user input in response to a large language model. For example, the input vector, along with the list of closely corresponding skills are compared. By calculating similarity scores between the user input and the skill vectors, the chatbot can determine which skill most closely aligns with the user's query. This process often involves techniques like cosine similarity or Euclidean distance to measure the similarity between vectors. Additionally, machine learning models, such as decision trees or neural networks, can be trained on historical data to further refine the skill identification process and improve the chatbot's accuracy over time. The identified, closest matching skill can be returned from the large language model. Finally, the method 400 is then configured for initiating 460 the one of the plurality of skills in response to a determination of closest matching skill.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium”may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The various tasks performed in connection with the process may be performed by software, hardware, firmware, or any combination thereof. For illustrative purposes, the following description of process may refer to elements mentioned above. In practice, portions of process may be performed by different elements of the described system, e.g., component A, component B, or component C. It should be appreciated that process may include any number of additional or alternative tasks, the tasks shown need not be performed in the illustrated order, and process may be incorporated into a more comprehensive procedure or process having additional functionality not described in detail herein. Moreover, one or more of the tasks shown could be omitted from an embodiment of the process as long as the intended overall functionality remains intact.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A non-transitory computer readable medium having computer instructions stored therein that when executed by a computer system cause the computer system to perform operations for responding in a chatbot application comprising:
storing a plurality of skills vectors in a memory wherein each of the plurality of skills vectors is associated with a skill to be initiated by the chatbot application;
receiving a user input from the chatbot application;
generating an input vector in response to the user input;
performing a semantic search with the input vector on the plurality of skills vectors to generate a list of skills matching, within a threshold amount, an intent of the user input;
identifying one of the plurality of skills in response to the list of skills and the user input in response to a large language model; and
initiating the one of the plurality of skills in response to a determination of the one of the plurality of skills.

2. The non-transitory computer readable medium of claim 1, wherein the identifying of one of the plurality of skills generates a closeness value for each of the plurality of skills to determine a match to one of the plurality of skills when the closeness value is less than the threshold amount.

3. The non-transitory computer readable medium of claim 1, wherein the one of the plurality of skills is determined in response to the input vector matching one of the plurality of skills vectors with a closeness value being less than a second threshold amount and wherein the threshold amount is greater than the second threshold amount.

4. The non-transitory computer readable medium of claim 1, wherein the input vector and an indication of a match between the input vector and the one of the plurality of skills are stored in the memory as an additional one of the plurality of skills vectors.

5. The non-transitory computer readable medium of claim 1, wherein a cosine similarity is used to perform the semantic search.

6. The non-transitory computer readable medium of claim 1, wherein the input vector is a numerical representation of the user input.

7. The non-transitory computer readable medium of claim 1, wherein the determining one of the plurality of skills is performed by the large language model.

8. The non-transitory computer readable medium of claim 1, wherein the large language model generates a response vector and a response utterance.

9. The non-transitory computer readable medium of claim 1, wherein the chatbot application is performed on a user device and the determining one of the plurality of skills in response to the list of skills and the user input using the large language model is performed on a remote device and wherein the one of the plurality of skills, the list of skills and the user input are transmitted via a data network.

10. A method for performing a dialog session comprising:
receiving a user input from a chatbot application wherein the user input is indicative of a user intent associated with one of a plurality of skills;
generating an input vector in response to the user input;
generating a list of skills in response to a semantic search comparing the input vector to a plurality of skills vectors where each of the plurality of skills vectors is associated with one of the plurality of skills, to determine the list of skills matching the input vector;
identifying an intended skill from the list of skills in response to the list of skills and the input vector using a large language model; and
performing the intended skill in response to an identification of the intended skill.

11. The method of claim 10 further including storing the intended skill and the input vector in a memory and wherein the input vector becomes one of the plurality of skills vectors and the intended skill becomes one of the plurality of skills.

12. The method of claim 10 wherein the generating the list of skills further generates a closeness value between each of the plurality of skills vectors and the input vector and wherein a skill is included in the list of skills in response to the closeness value being greater than a threshold value.

13. The method of claim 10 wherein the generating the list of skills further generates a closeness value between each of the plurality of skills vectors and the input vector and wherein a skill is included in the list of skills in response to the closeness value being less than a threshold value and wherein the intended skill is identified from the list of skills in response to the closeness value being greater than a second threshold value wherein the second threshold value is greater than the threshold value and wherein the large language model is not performed in response to the closeness value being greater than the second threshold value.

14. The method of claim 10 wherein the input vector and an indication of a match between the input vector and the one of the plurality of skills are stored in a memory as an additional one of the plurality of skills vectors.

15. The method of claim 10 wherein a Euclidean distance is used to perform the semantic search.

16. The method of claim 10 wherein a Manhattan distance is used to perform the semantic search.

17. The method of claim 10 wherein the semantic search is performed on a user device and the large language model is performed on a network device.

18. The method of claim 17 wherein the list of skills, the input vector and the intended skill are transmitted between the user device and the network device via a wireless network.

19. A system for performing a dialog session comprising:
a user interface receiving a user input indicative of a user intent;
a memory configured for storing a plurality of skills vectors wherein each of the plurality of skills vectors is associated with a skill to be initiated by a chatbot application;
a processor configured to generate an input vector in response to the user input and a list of skills in response to a semantic search comparing the input vector to the plurality of skills vectors where each of the plurality of skills vectors is associated with one of the plurality of skills, to determine the list of skills matching the input vector, the processor being further configured for identifying an intended skill from the list of skills in response to the list of skills and the input vector using a large language model; and
a skills processor for executing the intended skill in response to an identification of the intended skill.

20. The system of claim 19 wherein the generating the list of skills further generates a closeness value between each of the plurality of skills vectors and the input vector and wherein the intended skill is included in the list of skills in response to the closeness value being less than a threshold value and wherein the intended skill is identified from the list of skills in response to the closeness value being greater than a second threshold value wherein the second threshold value is greater than the threshold value and wherein the large language model is not performed in response to the closeness value being greater than the second threshold value.
